(19) United States
(12) Patent Application Publication
(10) Pub. No.: US 2025/0023494 A1
(43) Pub. Date: Jan. 16, 2025

(54) START-UP DEVICE, MOTOR SYSTEM AND METHOD FOR REDUCING DC MOTOR START-UP CURRENT

(71) Applicant: Carrier Corporation, Palm Beach Gardens, FL (US)

(72) Inventors: Jie Liu, Shanghai (CN); Hai Tian, Shanghai (CN); Chen Zheng, Shanghai (CN)

(21) Appl. No.: 18/761,622

(22) Filed: Jul. 2, 2024

(30) Foreign Application Priority Data
Jul. 10, 2023 (CN) 2023108413213

(51) Int. Cl. H02P 1/18; H02P 1/02; H02P 7/291

(52) U.S. Cl. CPC H02P 1/18; H02P 1/022; H02P 7/291

(57) ABSTRACT

The present application relates to a motor control technology, and in particular to a start-up device for a DC motor, a motor system comprising the start-up device, a method for reducing DC motor start-up current and a computer-readable storage medium with a computer program stored thereon for implementing the above method. The start-up device for a DC motor according to one aspect of the present application includes: a switching element connected in series within a circuit comprising the DC motor and a DC power supply; and a control unit configured to cause the switching element to periodically switch between an ON state and an OFF state in a predetermined time interval to reduce the peak value of a start-up current flowing through the DC motor, and to cause the switching element to maintain the ON state after the predetermined time interval ends.

### CROSS REFERENCE TO A RELATED APPLICATION

The application claims the benefit of China Patent Application No. 202310841321.3 filed Jul. 10, 2023, the contents of which are hereby incorporated in their entirety.

### TECHNICAL FIELD

The present application relates to a motor control technology, and in particular to a start-up device for a DC motor, a motor system comprising the start-up device, a method for reducing DC motor start-up current and a computer-readable storage medium with a computer program stored thereon for implementing the above method.

### BACKGROUND

The start-up current of a brushed DC motor commonly has a relatively high peak value, typically multiple times higher than rated current. This necessitates the use of high-standard and high-quality electronic components (e.g. a metal-oxide-semiconductor field-effect transistor (MOSFET), a current sampling resistor, a protecting fuse and a wire gauge etc.), leading to product costs remaining high. In addition, even if the above technical measure has been taken, it is still difficult to avoid component burning during long-term use. Therefore, reducing DC motor start-up current is an urgent problem to be solved.

### SUMMARY

According to one aspect of the present application, there is provided a start-up device for a DC motor, comprising:
a switching element connected in series within a circuit comprising the DC motor and a DC power supply; and
a control unit configured to cause the switching element to periodically switch between an ON state and an OFF state in a predetermined time interval to reduce a peak value of a start-up current flowing through the DC motor, and to cause the switching element to maintain the ON state after the predetermined time interval ends.

Optionally, the above start-up device further comprises an overcurrent protection component coupled between the DC power supply and the DC motor.

Optionally, the above start-up device further comprises a capacitor connected between positive and negative terminals of the DC motor to absorb electromagnetic pulse components generated by the DC motor.

Apart from the aforementioned one or more features, in the above start-up device, the switching element is a metal-oxide-semiconductor field-effect transistor (MOSFET) with its gate coupled to the control unit, one of its source and drain coupled to the positive or negative terminal of the DC motor, and the other coupled to ground.

Optionally, in the start-up device, the control unit causes the switching element to periodically switch between the ON state and the OFF state by applying a pulse width modulation (PWM) signal to the gate.

Optionally, in the start-up device, a frequency of the pulse width modulation (PWM) signal is set such that a value of the start-up current at the start of the predetermined time interval is smaller than a first threshold value.

Optionally, in the start-up device, a length of the predetermined time interval is set to be greater than a second threshold value, so that the value of the start-up current at the start of the predetermined time interval is greater than a value when the switching element begins to maintain the ON state.

According to another aspect of the present application, there is provided a motor system, comprising:
a DC motor, comprising positive and negative terminals; and
a start-up device, comprising:
a switching element connected in series within a circuit comprising the DC motor and a DC power supply; and
a control unit configured to cause the switching element to periodically switch between an ON state and an OFF state in a predetermined time interval to reduce a peak value of a start-up current flowing through the DC motor, and to cause the switching element to maintain the ON state after the predetermined time interval ends.

According to yet another aspect of the present application, there is provided a method for reducing DC motor start-up current, comprising:
causing a switching element connected in series within a circuit comprising the DC motor and a DC power supply to periodically switch between an ON state and an OFF state in a predetermined time interval to reduce a peak value of a start-up current flowing through the DC motor; and
causing the switching element to maintain the ON state after the predetermined time interval ends.

According to still another aspect of the present application, there is provided a computer-readable storage medium, with a computer program stored thereon suitable for execution on a processor of a terminal device, the execution of the computer program enabling the steps of the method as described above to be performed.

### BRIEF DESCRIPTION OF THE DRAWINGS

The above and/or other aspects and advantages of the present application will become clearer and easier to understand in conjunction with the following description in various aspects of the drawings. The same or similar units in the drawings are represented by the same reference numerals. The drawings include:

FIG. 1 shows a schematic block diagram of a start-up device for a DC motor according to some embodiments of the present application.

FIG. 2 shows a schematic circuit diagram of a start-up device for a DC motor according to some other embodiments of the present application.

FIG. 3 exemplarily illustrates the relationship of a start-up current over time in the circuit shown in FIG. 2 under the conventional start-up mode for a DC motor.

FIG. 4 exemplarily illustrates the relationship of a start-up current over time in the circuit shown in FIG. 2 under the DC motor start-up mode according to some embodiments of the present application.

FIG. 5 shows a flow diagram of a method for reducing DC motor start-up current according to some other embodiments of the present application.

FIG. 6 shows a schematic block diagram of a typical control device.

### DETAILED DESCRIPTION OF EMBODIMENTS

The present application will be more fully described hereinafter with reference to the drawings of the exemplary embodiments of the present application. However, the present application may be implemented in different forms, and should not be construed as being limited only by the various embodiments provided herein. The various embodiments aim to make the present application more comprehensive and complete, so that the protection scope of the present application would be more fully conveyed to a person skilled in the art.

In this specification, the terms such as “comprise” and “include” indicate that in addition to the units and steps directly and explicitly stated in the specification and claims, the technical solution of the present application also does not exclude the circumstances where there are other units and steps that are not directly or explicitly stated.

In this specification, the terms such as “A and B coupled” and “A coupled to B” denote the following circumstances: i) A and B have a direct electrical or mechanical connection, etc.; ii) A and B are electrically or mechanically connected through C, etc.

Unless otherwise specified, in this specification, the terms such as “first” and “second” do not indicate the sequence of units in such aspects as time, space, size, etc., but are only used to distinguish between units.

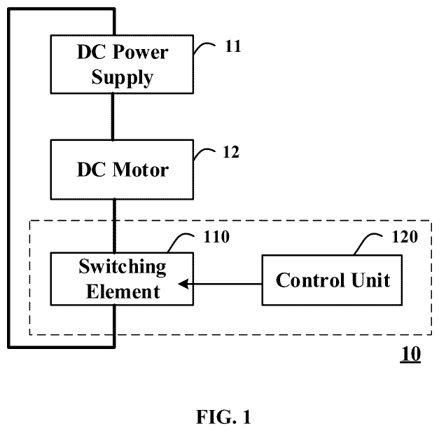

FIG. 1 shows a schematic block diagram of a start-up device for a DC motor according to some embodiments of the present application. It should be pointed out that, in addition to the units shown in FIG. 1, the start-up device further includes other units essential for implementing the start-up function. However, for the sake of conciseness, the description of FIG. 1 only involves units that are directly related to the subject of reducing start-up current.

The start-up device 10 shown in FIG. 1 includes a switching element 110 and a control unit 120. Referring to FIG. 1, the positive and negative terminals of a DC motor 11 are coupled to a DC power supply 12 and the switching element 110, respectively. It is worth mentioning that, in addition to the circumstances as illustrated, the switching element 110 may also be connected in series in other locations within a circuit L comprising the DC motor and the DC power supply 12. For instance, the switching element 110 may be located between the positive terminal of the DC motor 11 and the DC power supply 12.

On the other hand, the control unit 120 is coupled to the control terminal of the switching element 110 to control the ON-OFF state of the switching element 110. In some embodiments, the control unit 120 regulates the peak value of the start-up current (hereinafter referred to as the peak start-up current) Ip of the DC motor 11 by controlling the ON-OFF state of the switching element 110. Specifically, in a predetermined time interval Ts, the control unit 120 may cause the switching element 110 to periodically switch between an ON state and an OFF state to reduce the peak start-up current Ip flowing through the DC motor. The predetermined time interval Ts described herein corresponds to a start-up phase of the DC motor 11, and thus can be understood as a start-up period of the DC motor. After the start-up period is over, the control unit 120 will cause the switching element 110 to maintain the ON state.

In some embodiments, the switching element 110 is implemented using a metal-oxide-semiconductor field-effect transistor (MOSFET) with its gate coupled to the control unit 120, one of the source S and drain D coupled to the positive or negative terminal of the DC motor 11, and the other coupled to ground.

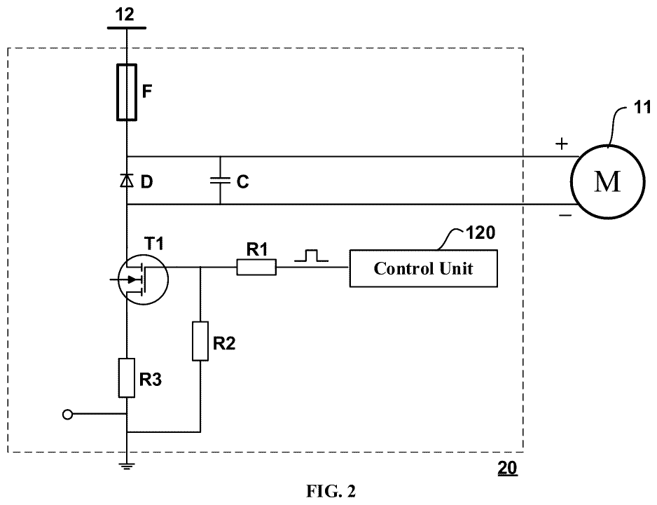

FIG. 2 shows a schematic circuit diagram of a start-up device for a DC motor according to some other embodiments of the present application.

In the circuit 20 illustrated by FIG. 2, the switching element is implemented using an NMOS tube T1 with its gate G connected to the control unit 120 via a resistor R1 and grounded via a voltage divider resistor R2, the drain D connected to the negative terminal of the DC motor 11, and the source S grounded via a current sampling resistor R3. It should be noted that, the type of the MOS tube as illustrated herein is merely exemplary, and in some alternative implementations, a PMOS tube may also be used as the switching element 110. Furthermore, the way of connecting the MOS tube to the DC motor and other units, and the location thereof in the circuit, as illustrated in FIG. 2, are also only exemplary. Other alternative ways, for example, include, but are not limited to: the source S of the NMOS tube T1 is coupled to the negative terminal of the DC motor 11, and the drain D is grounded via the current sampling resistor R3; or the NMOS tube T1 is coupled between the DC power supply 12 and the positive terminal of the DC motor 11, wherein the source S (drain D) is coupled to the DC power supply 12, and the drain D (source S) is coupled to the positive terminal of the DC motor 11.

Continuing to refer to FIG. 2, the circuit 20 further includes an overcurrent protection component F (e.g. a protecting fuse) connected between the DC power supply 12 and the positive terminal of the DC motor 11, and a capacitor C (for absorbing electromagnetic pulse components generated by the DC motor) connected between the positive and negative terminals of the DC motor 11. The circuit 20 still further includes a diode D reversely connected between the positive and negative terminals of the DC motor 11.

In the embodiments illustrated by FIG. 2, the control unit 120 may enable the switching element (specifically illustrated by the NMOS tube T1) to periodically switch between an ON state and an OFF state by applying a pulse width modulation (PWM) signal to the gate G.

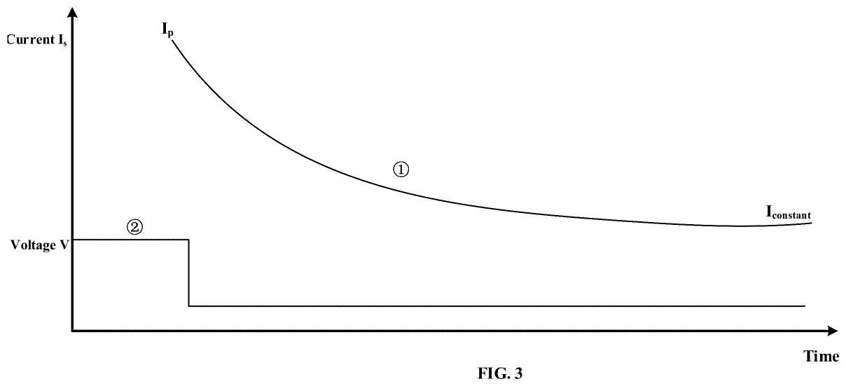

FIG. 3 exemplarily illustrates the relationship of a start-up current over time in the circuit shown in FIG. 2 under the conventional start-up mode for a DC motor, wherein the horizontal axis represents time, and the vertical axis represents the magnitude of the start-up current Is measured at the positive terminal of the DC motor and the magnitude of the voltage V measured at the negative terminal of the DC motor. In particular, in FIG. 3, \textcircled{1} represents a curve of variation of the start-up current Is of the DC motor 11 over time, and \textcircled{2} represents a curve of variation of the voltage V over time.

When the control signal applied to the gate G jumps from a low level to a high level, the circuit where the DC motor is located is rapidly switched from an ON state to an OFF state. Correspondingly, as illustrated in FIG. 3, the voltage V jumps from a high potential to a low potential, and the start-up current Iₛ is at its maximum or peak value Iₚ; thereafter, the start-up current Is gradually decreases over time until it reaches or approaches a constant current value I_{constant}.

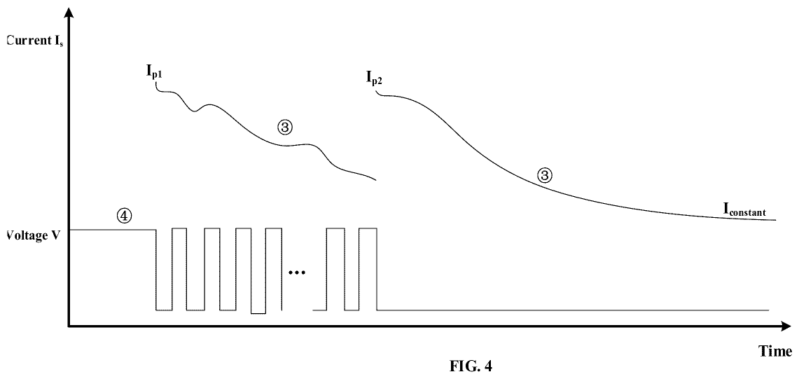

FIG. 4 exemplarily illustrates the relationship of a start-up current over time in the circuit shown in FIG. 2 under the DC motor start-up mode according to some embodiments of the present application, wherein the horizontal axis represents time, and the vertical axis represents the magnitude of the start-up current Is measured at the positive terminal of the DC motor and the magnitude of the voltage V measured at the negative terminal of the DC motor. In particular, in FIG. 4, \textcircled{3} represents a curve of variation of the start-up current Is of the DC motor 11 over time, and \textcircled{4} represents a curve of variation of the voltage V over time.

Referring to FIG. 4, unlike the start-up mode shown in FIG. 3, in a predetermined time interval Tₛ, the control signal applied to the gate G is provided in the form of a PWM signal, so that the switching element 110 or the MOS tube T1 periodically switches between an ON state and an OFF state. Accordingly, the voltage V periodically switches between a high potential and a low potential, and the start-up current Iₛ exhibits a peak value Iₚ₁ at the start of the time interval Tₛ and gradually decreases in a wave-like manner over time. After the time interval Tₛ ends, the control signal applied to the gate G is kept at a high level, and the switching element maintains the ON state. Correspondingly, the voltage V is kept at a low level, and the start-up current Iₛ jumps to another peak value Iₚ₂ when the switching element begins to maintain the ON state, and gradually decreases over time until it reaches or approaches a constant current value I_{constant}. Upon comparison of FIGS. 3 and 4, it is evident that the peak start-up currents Iₚ₁ and Iₚ₂ in FIG. 4 are smaller than the peak start-up current Iₚ in FIG. 3. That is, the peak start-up current flowing through the DC motor can be reduced by causing the switching element to periodically switch between an ON state and an OFF state.

The inventors of the present application have found, after in-depth research, that by selecting the frequency of the PWM signal applied to the gate G, the peak start-up currents Iₚ₁ and Iₚ₂ can be reduced to desired levels. In particular, the peak start-up currents Iₚ₁ and Iₚ₂ decrease as the frequency of the PWM signal increases.

The inventors of the present application have also found, after in-depth research, that contrary to intuitive understanding, when the control terminal of the switching element is applied with a PWM signal, the peak start-up current Iₚ₁ is not always greater than the peak value Iₚ₂. In other words, merely controlling the peak start-up current Iₚ₁ below the desired level does not ensure that the peak value of the start-up current is below the desired level. This implies that in order to reduce the peak start-up current, it is necessary to choose a higher PWM signal frequency, thus facing more challenges in terms of costs and circuit design.

Upon further research, the inventors of the present application have found that by making the predetermined time interval Tₛ sufficiently large, the peak value Iₚ₁ could be greater than the peak value Iₚ₂.

Based on the above findings, in some embodiments of the present application, the start-up current of the DC motor can be reduced through the following means: first, lowering the peak start-up current Iₚ₁ to the desired level by selecting the frequency of the PWM signal applied to the gate G; then, ensuring that the peak value Iₚ₁ is greater than the peak value Iₚ₂ by choosing the predetermined time interval Tₛ. In this way, it is possible to circumvent such issues as increased costs and rise in complexity of circuit design resulted from using a higher PWM signal frequency.

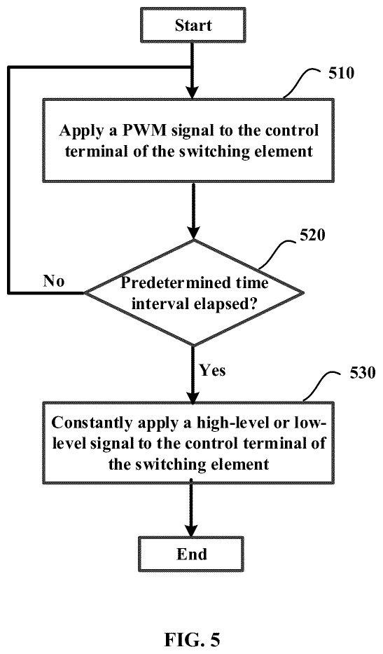

FIG. 5 shows a flow diagram of a method for reducing DC motor start-up current according to some other embodiments of the present application. Exemplarily, the method described hereinafter is implemented by means of the start-up device shown in FIG. 1 or FIG. 2.

The method illustrated by FIG. 5 includes the following steps:
Step 510: The control unit 120 causes the switching element 110 to periodically switch between an ON state and an OFF state, for example, by applying a PWM signal to the control terminal (e.g. the gate G) of the switching element 110.
Step 520: The control unit 120 determines whether a predetermined time interval Tₛ has elapsed since the application of the PWM signal; if the time interval Tₛ has elapsed, the process proceeds to step 530; otherwise, it returns to step 510.
Step 530: The control unit 120 causes the switching element 110 to maintain the ON state, for example, by constantly applying a high-level signal (in the event of the switching element being a NMOS tube) or a low-level signal (in the event of the switching element being a PMOS tube) to the control terminal (e.g. the gate G) of the switching element 110.

Optionally, the frequency of the PWM signal is set such that the value of the start-up current at the start of the time interval Tₛ is less than a first threshold value TH1.

Further optionally, the length of the predetermined time interval Tₛ is set to be greater than a second threshold value TH2, so that the value of the start-up current at the start of the predetermined time interval Tₛ (peak value Iₚ₁) is greater than the value when the switching element begins to maintain the ON state (peak value Iₚ₂).

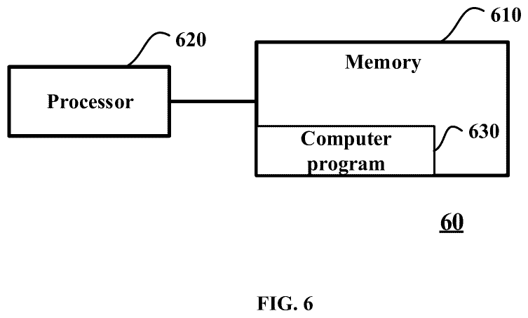

FIG. 6 shows a schematic block diagram of a typical control device. The control device shown in FIG. 6 can be used for implementing the control unit shown in FIGS. 1 and 2.

As illustrated in FIG. 6, the control device 60 includes a memory 610 (for example, a non-volatile memory such as flash memory, ROM, hard drive, magnetic disk and optical disk), a processor 620, and a computer program 630.

The memory 610 stores the computer program 630. The processor 320 is configured to execute the computer program 630 stored on the memory 610 to implement one or more steps included in the method illustrated by FIG. 5.

According to another aspect of the present application, there is also provided a computer-readable storage medium, with a computer program stored thereon (e.g. the computer program 630 in FIG. 6). The program, when executed by a processor (e.g. the processor 620 in FIG. 6), can implement the one or more steps in the method illustrated by FIG. 5.

The computer-readable storage medium as referred to in the present application includes various types of computer storage media, which may be any usable medium accessible by a general-purpose or specialized computer. For example, the computer-readable storage medium may include RAM, ROM, EPROM, E2PROM, register, hard disk, removable disk, CD-ROM or other optical disk memory, disk memory or other magnetic storage device, or any other temporary or non-temporary medium capable of carrying or storing desired program code units in the form of instructions or data structures and also capable of being accessed by a general-purpose or specific-purpose computer or processor. The combination of the above should also be included within the scope of protection of the computer-readable storage medium. An exemplary storage medium is coupled to a processor to enable the processor to read and write information from/to the storage medium. In alternative solutions, the storage medium may be integrated into the processor. The processor and the storage medium may reside in an ASIC. The ASIC may reside in a user terminal. In alternative solutions, the processor and the storage medium may reside as separate components within the user terminal.

A person skilled in the art will appreciate that, various illustrative logic blocks, modules, circuits and algorithmic steps described herein may be implemented as electronic hardware, computer hardware or a combination of both.

To demonstrate interchangeability between hardware and software, various illustrative components, blocks, modules, circuits and steps have been described above in general terms based on their functionality. Such functionality is implemented in the form of hardware or software, depending on particular applications and design constraints imposed on the overall system. A person skilled in the art may implement the described functionality in varying ways for particular applications, but such implementation decisions should not be construed to result in a departure from the scope of the present application.

While only some embodiments of the present application are described, it should be understood by a person skilled in the art that the present application can be implemented in various other forms without departing from its main purpose and scope. Therefore, the examples and embodiments provided are intended to be illustrative rather than restrictive, and the present application may encompass various modifications and substitutions without departing from the spirit and scope of the present application as defined in the appended claims.

The embodiments and examples are provided herein to best explain the embodiments of the technology and its particular application, so that a person skilled in the art can exploit and implement the present application. However, a person skilled in the art will appreciate that the foregoing description and examples are provided for the purpose of illustration and exemplification only. The description provided is not intended to cover every aspect of the present application or to limit the present application to the precise form disclosed.

What is claimed is:

1. A start-up device for a DC motor, comprising:
a switching element connected in series within a circuit comprising the DC motor and a DC power supply; and
a control unit configured to cause the switching element to periodically switch between an ON state and an OFF state in a predetermined time interval to reduce a peak value of a start-up current flowing through the DC motor, and to cause the switching element to maintain the ON state after the predetermined time interval ends.

2. The start-up device according to claim 1, further comprising an overcurrent protection component coupled between the DC power supply and the DC motor.

3. The start-up device according to claim 1, further comprising a capacitor connected between positive and negative terminals of the DC motor to absorb electromagnetic pulse components generated by the DC motor.

4. The start-up device according to claim 1, wherein the switching element is a metal-oxide-semiconductor field-effect transistor with a gate thereof coupled to the control unit, one of a source and a drain thereof coupled to the positive or negative terminal of the DC motor, and the other coupled to ground.

5. The start-up device according to claim 4, wherein the control unit causes the switching element to periodically switch between the ON state and the OFF state by applying a pulse width modulation signal to the gate.

6. The start-up device according to claim 5, wherein a frequency of the pulse width modulation signal is set such that a value of the start-up current at the start of the predetermined time interval is smaller than a first threshold value.

7. The start-up device according to claim 6, wherein a length of the predetermined time interval is set to be greater than a second threshold value, so that the value of the start-up current at the start of the predetermined time interval is greater than a value when the switching element begins to maintain the ON state.

8. A motor system, comprising:
a DC motor, comprising positive and negative terminals; and
a start-up device, comprising:
a switching element connected in series within a circuit comprising the DC motor and a DC power supply; and
a control unit configured to cause the switching element to periodically switch between an ON state and an OFF state in a predetermined time interval to reduce a peak value of a start-up current flowing through the DC motor, and to cause the switching element to maintain the ON state after the predetermined time interval ends.

9. The motor system according to claim 8, wherein the start-up device further comprises an overcurrent protection component coupled between the DC power supply and the DC motor.

10. The motor system according to claim 8, wherein the start-up device further comprises a capacitor connected between the positive and negative terminals of the DC motor to absorb electromagnetic pulse components generated by the DC motor.

11. The motor system according to claim 8, wherein the switching element is a metal-oxide-semiconductor field-effect transistor with a gate thereof coupled to the control unit, one of a source and a drain thereof coupled to the positive or negative terminal of the DC motor, and the other coupled to ground.

12. The motor system according to claim 11, wherein the control unit causes the switching element to periodically switch between the ON state and the OFF state by applying a pulse width modulation signal to the gate.

13. The motor system according to claim 12, wherein a frequency of the pulse width modulation signal is set such that a value of the start-up current at the start of the predetermined time interval is smaller than a first threshold value.

14. The motor system according to claim 13, wherein a length of the predetermined time interval is set to be greater than a second threshold value, so that the value of the start-up current at the start of the predetermined time interval is greater than a value when the switching element begins to maintain the ON state.

15. A method for reducing DC motor start-up current, comprising:
causing a switching element connected in series within a circuit comprising the DC motor and a DC power supply to periodically switch between an ON state and an OFF state in a predetermined time interval to reduce a peak value of a start-up current flowing through the DC motor; and
causing the switching element to maintain the ON state after the predetermined time interval ends.

16. The method according to claim 15, wherein the switching element is implemented using a metal-oxide-semiconductor field-effect transistor.

17. The method according to claim 16, wherein the switching element periodically switches between the ON state and the OFF state by applying a pulse width modulation signal to the gate of the metal-oxide-semiconductor field-effect transistor.

18. The method according to claim 17, wherein a frequency of the pulse width modulation signal is set such that a value of the start-up current at the start of the predetermined time interval is smaller than a first threshold value.

19. The method according to claim 18, wherein a length of the predetermined time interval is set to be greater than a second threshold value, so that the value of the start-up current at the start of the predetermined time interval is greater than a value when the switching element begins to maintain the ON state.

20. A computer-readable storage medium, with instructions stored thereon, wherein the instructions, when executed by a processor, enable the processor to perform the method according to claim 15.
